(19) United States
(12) Patent Application Publication
(10) Pub. No.: US 2026/0225600 A1
(43) Pub. Date: Aug. 6, 2026

(54) DRIVER BEHAVIOR BASED ADAPTIVE SPEED LIMITING DUE TO FAULT AND/OR ENABLEMENT OF A SPEED LIMITING DRIVING MODE

(71) Applicant: GM GLOBAL TECHNOLOGY OPERAITONS LLC, Detroit, MI (US)

(72) Inventors: Brian Patrick HANNON Jr., Grand Blanc, MI (US); Christopher Lyman JONES, Atlanta, GA (US)

(21) Appl. No.: 19/044,710

(22) Filed: Feb. 4, 2025

(51) Int. Cl. B60W 50/038; B60W 30/14

(52) U.S. Cl. CPC B60W 50/038; B60W 30/146; B60W 2520/10; B60W 2720/10

(57) ABSTRACT

An adaptive speed limiting system includes: a vehicle control module that i) at least one of detects a fault in a host vehicle and enables operation in a driving mode during which a maximum speed limit is imposed, and ii) at least one of limits output torque of a propulsion system and speed of the host vehicle based on a current maximum speed limit; and a speed limiting module that i) based on at least one of the detected fault and operation in the driving mode, initiates adaptive speed limiting to impose the current maximum speed limit, ii) determines speed limit windows having respective speed ranges, iii) determines an average speed of the host vehicle, and iv) based on the average speed and the speed limit windows, periodically decreases the current maximum speed limit until the current maximum speed limit is equal to a target maximum speed limit.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to speed limiting vehicle systems and methods.

A modern vehicle can include various systems including various controllers, components, and sensors. When a fault occurs in one of these systems, components and/or sensors, it can be appropriate to limit speed of the vehicle for safety reasons and/or to prevent damaging and/or degrading one or more system components. This can be accomplished by setting a reduced speed limit and ramping down speed of the vehicle to be less than or equal to the reduced speed limit. As an example, a reduced speed limit may be 25 miles per hour (or 40 kilometers per hour (kph)). The vehicle ramps the speed of the vehicle down to the reduced speed limit to allow the vehicle to travel to a safe location, a repair facility, etc.

### SUMMARY

An adaptive speed limiting system is disclosed and includes: a propulsion system configured to move a host vehicle; a vehicle control module configured to i) at least one of detect a fault in the host vehicle and enable operation in a driving mode during which a maximum speed limit is imposed, and ii) at least one of limit output torque of the propulsion system and speed of the host vehicle based on a current maximum speed limit; and a speed limiting module configured to i) based on at least one of the detected fault and operation in the driving mode, initiate adaptive speed limiting to impose the current maximum speed limit to change driving behavior, ii) determine speed limit windows having respective speed ranges, iii) determine an average speed of the host vehicle, and iv) based on the average speed and the speed limit windows, periodically decrease the current maximum speed limit until the current maximum speed limit is equal to a target maximum speed limit.

In other features, the speed limiting module is configured to i) monitor the speed of the host vehicle, and ii) in response to the speed of the host vehicle remaining within upper and lower bounds of a current one of the speed limit windows for a transient predetermined period of time, decrease the current maximum speed limit to a next lower one of maximum speed limits. The speed limit windows correspond respectively to the maximum speed limits.

In other features, the speed limiting module is configured to iteratively step down the current maximum speed limit until the current maximum speed limit is equal to the target maximum speed limit.

In other features, the speed limiting module is configured to: reset a transient timer each time the speed of the host vehicle exits one of the speed limit windows; iteratively increment the transient timer while the speed of the host vehicle is in the one of the speed limit windows; and based on the transient timer, decrease the current maximum speed limit.

In other features, the speed limiting module is configured to reset the transient timer each time the speed of the host vehicle exits the one of the speed limit windows prior to the transient timer reaching a transient predetermined period of time.

In other features, the speed limiting module is configured to, subsequent to one or more of the speed limit windows, ramp down the speed of the host vehicle to be less than the target maximum speed limit.

In other features, the speed limiting module is configured to begin ramping down the speed of the host vehicle a determined period of time prior to a maximum time point from when adaptive speed limiting is initiated.

In other features, the speed limiting module is configured to refrain from ramping down the speed of the host vehicle during the speed limiting windows.

In other features, the speed limiting module allows a driver to adjust speed of the host vehicle during periods of the speed limiting windows while limiting the speed of the host vehicle based on respectively maximum speed limits. The maximum speed limits include the current maximum speed limit.

In other features, the speed limiting module is configured to i) initiate a cumulative timer indicative of an amount of time the speed of the host vehicle is in one of the speed limit windows during a period when the speed of the host vehicle enters and exits the one of the speed limit windows multiple times, and ii) decrease the current maximum speed limit based on a state of the cumulative timer.

In other features, the speed limiting module is configured to delay determining an initial speed limiting window when the current maximum speed limit is equal to a minimum speed limit.

In other features, the speed limiting module is configured to delay evaluating the speed of the host vehicle relative to one of the speed limit windows when the current maximum speed limit is equal to a minimum speed limit.

In other features, the speed limiting module is configured to delay reducing the current maximum speed limit when the current maximum speed limit is equal to a minimum speed limit.

In other features, durations of the speed limit windows are different.

In other features, upper bounds of the speed limit windows are less than or equal to respectively maximum speed limits imposed by the speed limiting module.

In other features, maximum speed limits imposed by the speed limiting module are independent of a maximum speed limit indicated by speed limit sign for current geographical location of the host vehicle. A minimum speed limit is imposed by the speed limiting module is a same value as a minimum speed limit indicated by the speed limit sign for the current geographical location.

In other features, an adaptive speed limiting method is disclosed and includes: moving a host vehicle via a propulsion system; at least one of detecting a fault in the host vehicle and enabling operation in a driving mode during which a maximum speed limit is imposed; at least one limiting output torque of the propulsion system and speed of the host vehicle based on a current maximum speed limit; based on at least one of the detected fault and operation in the driving mode, initiating adaptive speed limiting to impose the current maximum speed limit to change driving behavior; determining speed limit windows having respective speed ranges; determining an average speed of the host vehicle; and based on the average speed and the speed limit windows, periodically decreasing the current maximum speed limit until the current maximum speed limit is equal to a target maximum speed limit.

In other features, the adaptive speed limiting method further includes: monitoring the speed of the host vehicle; and in response to the speed of the host vehicle remaining within upper and lower bounds of a current one of the speed limit windows for a transient predetermined period of time, decreasing the current maximum speed limit to a next lower one of multiple maximum speed limits. The speed limit windows correspond respectively to the maximum speed limits.

In other features, the adaptive speed limiting method further includes: resetting a transient timer each time the speed of the host vehicle exits one of the speed limit windows; iteratively incrementing the transient timer while the speed of the host vehicle is in the one of the speed limit windows; and based on the transient timer, decreasing the current maximum speed limit.

In other features, the adaptive speed limiting method further includes: initiating a cumulative timer indicative of an amount of time the speed of the host vehicle is in one of the speed limit windows during a period when the speed of the host vehicle enters and exits the one of the speed limit windows multiple times; and decreasing the current maximum speed limit based on a state of the cumulative timer.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a functional block diagram of a vehicle system including a speed control system in accordance with the present disclosure;

FIG. 2 is a speed versus time graph illustrating speed limit windows and descending maximum speed limits in accordance with an embodiment of the present disclosure;

FIG. 3 is a speed versus time graph illustrating use of filtered speed to determine an initial speed limit window and delay due to a current maximum speed limit equaling a minimum speed limit in accordance with an embodiment of the present disclosure;

FIG. 4 is a speed versus time graph illustrating decrease in a maximum speed limit due to a cumulative timer exceeding a cumulative period limit in accordance with an embodiment of the present disclosure;

FIG. 5 is a speed versus time graph illustrating a first speed floor handling method including delaying maximum speed limit reduction due to a current maximum speed limit equaling a minimum speed limit until the minimum speed limit is reduced in accordance with an embodiment of the present disclosure;

FIG. 6 is a speed versus time graph illustrating a second speed floor handling method including delaying evaluation of whether to perform maximum speed limit reduction due to a current maximum speed limit equaling a minimum speed limit until the minimum speed limit is reduced in accordance with an embodiment of the present disclosure; and

FIGS. 7A-7C illustrates a speed limiting method in accordance with the present disclosure.

In the drawings, reference numbers may be reused to identify similar and/or identical elements.

### DETAILED DESCRIPTION

When a fault occurs within a host vehicle and/or a speed limiting driving mode of a host vehicle is enabled, a specific speed limit may be set to reduce a current speed of the host vehicle to be less than or equal to the speed limit. Upon setting the speed limit, if the current speed is above the speed limit, then the current speed can be ramped down to the speed limit. The vehicle speed is ramped down if the driver is driving at a speed above the desired speed limit. The ramping down of the speed limit can overly restrict speed of the host vehicle such that it prevents a driver from keeping up with traffic and/or accelerating to a driver desired speed. The ramping down of vehicle speed can, for example, prevent the host vehicle from changing lanes on a freeway, where vehicles are traveling at high speed, and exiting the freeway. This is because the maximum speed of the vehicle has been greatly reduced, which can cause a backup of traffic on the freeway.

The examples set forth herein implement adaptive speed limiting to provide a driver of a host vehicle additional time before a final target (or desired) speed limit is imposed. A driver behavior based adaptive speed limiting strategy is implemented to determine progressively lower maximum vehicle speed limits to impose on a driver while progressing toward a final desired maximum speed limit. The transition to these intermediary speed limits is triggered based on observed driver behavior (i.e., driver speed requests) over periods of time. The values of the maximum vehicle speed limits are set to minimize limitations to current driving needs (i.e., driver speed) based on the observed driver behavior.

In an embodiment, a host vehicle control module determines, selects, and/or obtains a series of descending maximum speed limits that are each imposed over time when certain conditions are met. This provides a driver additional time to operate within different speed limit windows before a lowest (or final target) speed limit is imposed. The driver is as a result able to drive the host vehicle to a safe location, a home, and/or a repair facility without being severely limited in vehicle speed. In an embodiment, the speed limit is stepped down over time. A series of speed limit windows are implemented. When the vehicle speed is within each of the windows for a predetermined period of time (e.g., 10 seconds(s)), a current speed limit is reduced to a next lower speed limit. This is done until either the final target speed limit is reached or a ramp down start time point has been reached. In an embodiment, the initial speed limit of the series of progressively reduced speed limits is set based on driving behavior (e.g., average driving speed) over last predetermined period of time (e.g., 60 s). The ramp down start time point is a predetermined period of time prior to a maximum time. The maximum time refers to an amount of time from when the speed limiting is enabled to when the final target speed limit is reached. The ramp down start time point is set based on a desired speed ramp down rate.

As an example, adaptive speed limiting may be implemented to limit vehicle speed and as a result get a host vehicle in a safer state in case a forced braking maneuver is needed. Adaptive speed limiting may be implemented to prevent automotive safety integrity level (ASIL)-A loss of propulsion (LOP) events (an ASIL-A LOP is a sudden loss of propulsion event) by providing at least, for example, 5 minutes of driving time at driving speeds over a predetermined speed such as a final target maximum speed limit (e.g., 40 kph). If a final target maximum speed limit (e.g., 40 kph) is applied immediately, as opposed to implementing the adaptive speed limiting methods disclosed herein, a driver could be effectively stuck in a dangerous situation and/or it may not be possible to drive the host vehicle to a safe location. Additionally, speed limiting too low on high-speed roads may lead to a potential rear end impact.

Minimum speed availability profiles may be implemented when requesting pull over events for system failures. Adaptive speed limiting is implemented further to encourage a driver to pull over as quickly as possible when the host vehicle indicates pulling over and stopping is the desired remedial actions to take. This is done without over limiting driving speed behaviors of the driver or putting the driver in a dangerous situation. A goal is to impose speed limits above what current driving of a host vehicle suggest for safe operation of the host vehicle.

In the following examples, when speed limits are set, a prewarning message is generated indicating to a driver a current maximum speed limit regardless of a current speed of a host vehicle. An example diagnostic trouble code (DTC) that may be set is one that indicates a vehicle function degraded and indicates the vehicle speed being limited to a set maximum vehicle speed. A driver instrument cluster (or driver information center) (DIC) may be used to display messages and speedometer. In an embodiment, each new maximum speed limit generates a new prewarning DIC message. The DIC message may pop up on a screen that shows the speedometer and other vehicle information such as a malfunction indicator light (MIL) (e.g., a check engine light) and/or selected gear. For example, if a host vehicle is driving at 70 kph and speed limited to 80 kph then a notification of an 80 kph speed limit is provided. A maximum speed limit notification may be provided when a maximum speed limit is reached and is actively limited. A maximum speed limit is always above a minimum speed limit (or floor). The minimum speed limit may be used to determine maximum speed limits as a backup strategy. In an embodiment, a default speed limit profile is used when input data is lost and/or invalid.

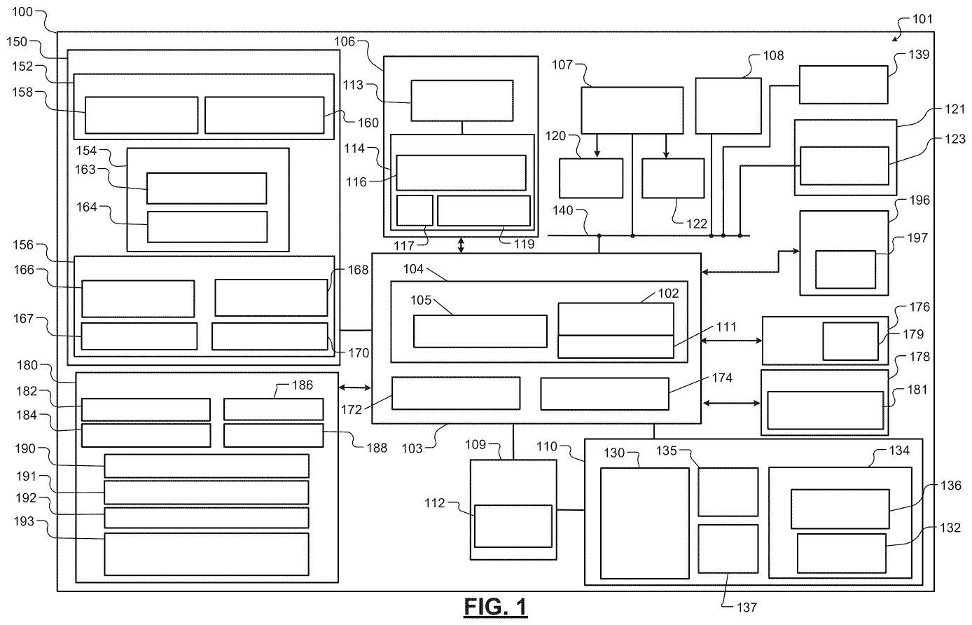

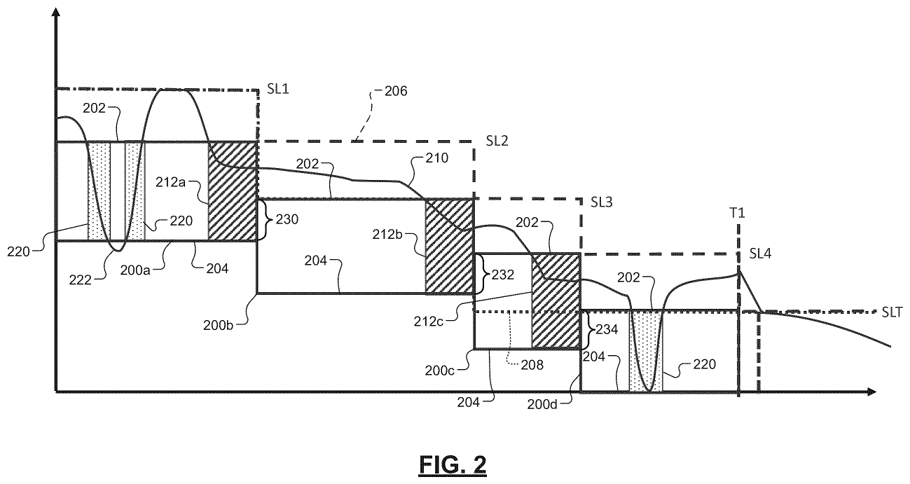

FIG. 1 shows a host vehicle 100 including a speed control system 101 including a speed limiting module 102. Some example operations of the speed control system 101 and the speed limiting module 102 are described below with respect to FIGS. 2-7C. The speed limiting module 102 may be implemented in a vehicle control module 103 as shown or may be separate from the vehicle control module 103. The speed limiting module 102 sets and imposes speed limits when certain conditions arise. The speed limits are imposed based on states of timers 111, such as a transient timer, a cumulative timer, and a maximum timer. These timers and the use thereof are described below. The speed limits may be set when a fault occurs, when the vehicle is implementing a speed limiting driving mode, and/or when other conditions arise. A fault may refer to a fault with a vehicle system, component, and/or sensor. An example fault is when an engine air temperature sensor is not operating appropriately and/or is not providing an output signal. The speed limiting module 102 reduces a maximum vehicle speed because the vehicle can no longer operate in a maximum vehicle performance domain. The maximum vehicle speed may be reduced to be less than or equal to 97 kph (or 60 mph), 56 kph (or 35 mph), 40 kph (or 25 mph), etc. An example speed limiting driving mode is a teen driving mode, which allows a parent to limit a maximum speed of the host vehicle 100 while a teenage child of the parent is driving the host vehicle 100.

The vehicle control module 103 includes a driving module 104 implementing a perception module 105 and the speed limiting module 102. The host vehicle may be a partially or fully autonomous vehicle, a vehicle with assisted driving capabilities, or a non-autonomous vehicle. The driving module 104 and/or perception module 105 performs: perception (or situation) determining operations; object detection, identification, classification, and graphical and visual identification operations; data look-up, collection, and gathering operations; interaction timing operations; assisted driving operations; image overlay operations; dialog operations including providing speech, text, and/or haptic messages; etc. The perception module 105 may determine the state of the host vehicle 100, environmental conditions, weather, states and locations of other nearby vehicles and objects, etc. The vehicle control module 103 may perform various operations based on determinations made by and/or outputs of the modules 102, 104, 105 and interactions with vehicle occupants such as a driver and/or passengers of the host vehicle 100.

The host vehicle 100 further includes one or more power sources 109, a telematics module 106, an infotainment module 107, other control modules 108 and a propulsion system 110. The vehicle control module 103 may control operation of the host vehicle 100 including the propulsion system 110 and other system described below. The power sources 109 may include one or more battery packs, a generator, a converter, a control circuit, terminals for high and low voltage loads, etc., as well as one or more battery sensors 112 for detecting states of the power sources 109 including voltages, current levels, states of charge, etc.

The telematics module 106 provides wireless communication services within the host vehicle 100 and wirelessly communicates with service providers, network devices (e.g., cloud-based network devices, central office devices, and/or back-office devices), other vehicles, mobile devices, infrastructure devices, and other devices external and/or internal to the host vehicle 100. The telematics module 206 may support Wi-Fi®, Bluetooth®, Bluetooth Low Energy (BLE), Ultra-Wideband (UWB), near-field communication (NFC), cellular, legacy (LG) transmission control protocol (TCP), long-term evolution (LTE), and/or other wireless communication and/or operate according to Wi-Fi®, Bluetooth®, BLE, UWB, NFC, cellular, and/or other wireless communication protocols. The telematics module 106 may include one or more transceivers 113 and a navigation module 114 with a global positioning system (GPS) and GNSS (or Global Navigation Satellite System) receiver 116. The navigation module 114 may include an inertial measurement unit (IMU) 117 and an odometer/wheel sensor 119. The transceivers 113 wirelessly communicate with network devices internal and external to the host vehicle 100 including cloud-based network devices, central stations, back-offices, and portable network devices. The transceivers 113 may perform pattern recognition, channel addressing, channel access control, and filtering operations.

The navigation module 114 executes a navigation application to provide navigation services. The navigation services may include location identification services to identify where the host vehicle 100 is located. The navigation services may also include guiding a driver and/or directing the host vehicle 100 to a selected location. The navigation module 114 may communicate with a central station to collect map information indicating levels of traffic, transportation object identification and locations (e.g., locations and types of signs), information regarding speed limit signs (e.g., locations and speed limits), path information, weather information, etc. As an example, if the host vehicle 100 is an assisted and/or automated driving vehicle, the navigation module 114 may direct the vehicle control module 103 along a selected route to a selected destination. The GPS and GNSS receiver 116 may provide: location information; velocity and/or direction (or heading) of the host vehicle 100, other vehicles, and objects (e.g., pedestrians and cyclists); and/or global clock timing information.

One or more HUDs (also referred to as augmented reality (AR) HUDs) 121 are included and may include one or more HUD control module(s) (one HUD control module 123 is shown). The HUD control module 123 is in communication with the modules 102, 103, 104 and displays speed limits including external speed limits indicated by speed limit signs located along the road traveled on and speed limits set and imposed by the speed limiting module 102. The speed limits set by the speed limiting module 102 override external speed limits. In an embodiment, when a speed limit is displayed by the speed limiting module 102, an external speed limit may not be displayed.

The infotainment module 107 may include and/or be connected to an audio system 122 and/or a video system including one or more displays. The displays 120, 121 and audio system 122 may be part of a human machine interface. The displays 120, 121 may include cluster and/or center console displays, etc. Haptic devices (e.g., steering wheel and/or seat vibration devices) may be used in addition to the displays 120, 121 and the audio system 122 to interact with a vehicle occupant such as a driver or passenger. This interaction is further described below. Messages may be displayed, audibly played out, and/or indicated via the displays 120, 121, the audio system 122, the haptic devices, and/or via one or more other output devices. The messages may include indications of detected faults and imposed speed limits set by the speed limiting module 102.

The infotainment module 107 may provide various information, warnings, and proactive messages including: status information; routing information, re-routing information, questions whether the host vehicle 100 should re-route from a current path to another path; whether driving operations are autonomously controlled, limited and/or prevented; gear shifter status; upcoming and currently being performed operations (e.g., braking, accelerating, turning operations); detected objects (or obstacles); vehicle status information; diagnostic information; prognostic information; entertainment features and information; etc. The infotainment module 107 may be used to guide a vehicle operator to a certain location, indicate trip estimations (e.g., distances to selected destinations), and other information.

The propulsion system 110 may include one or more torque sources, such as one or more motors and/or one or more engines (e.g., internal combustion engines). In the example shown in FIG. 1, the host vehicle 100 includes an engine 130 and one or more motors 132. The torque sources are independently controlled. The propulsion system 110 includes a motor control system 134 that includes the one or more motors 132 and a motor control module 136 that may control operation of the one or more motors 132 based on signals from the vehicle control module 103. The propulsion system 110 may include a gear selector and/or shifter 135 for setting a gear of a transmission 137 and/or for setting a drive state of one or more of the torque sources. The gear selector and/or shifter 135 may be an electronic selector (e.g., one or more electrical switches), a mechanical and/or electrical shifter, or other selector and/or shifter. The propulsion system 110 may be controlled based on position of an accelerator 139 (e.g., an accelerator pedal, a throttle plate, etc.).

The modules 102-108 and 123 may communicate with each other directly or indirectly via one or more buses 140, such as a controller area network (CAN) bus and/or other suitable interface. The vehicle control module 103 may control operation of vehicle modules, devices and systems based on feedback from sensors 150 and information and/or instructions received from a cloud-based network device.

The sensors 150 may include exterior sensors 152, interior sensors 154, and other sensors 156. The exterior sensors 152 may include radar and/or lidar sensors 158 and imaging and audio devices (e.g., visual spectrum cameras, long-wave infrared cameras, short-wave infrared cameras, ambient light sensors, and microphone or microphone array) 160. The exterior sensors 152 may be used to detect objects external to the host vehicle 100 and/or in a path of the host vehicle 100. The objects may include speed limit signs, other vehicles, pedestrians, bicyclists, and other objects. The exterior sensors 152 may be used to detect speed limit signs, read the speed limit signs, and determine speed limits for geographical locations of the speed limit signs. Image recognition software may be implemented to read the speed limit signs.

The interior sensors 154 may include one or more interior imaging sensors (e.g., cameras) 163, and a microphone or microphone array 164. The interior sensors 154 may be part of a driver monitoring system (DMS). The cameras 163 may be used to detect, track and/or monitor vehicle occupants including detecting locations of vehicle occupants in the vehicle, anatomical features (e.g., face, arms, hands, legs, etc.) of the vehicle occupants, head locations and/or eyes, etc. The interior sensors 154 may be used to detect gaze directions of a driver and/or vehicle occupants. The interior sensors 154 may include door sensors, seat belt sensors, seat sensors, etc. The door sensor may indicate whether a door is open or closed. The seat belt sensors may indicate whether seat belts are buckled. The seat sensor may include, for example, load sensors, strain gauges, and/or piezoresistive or piezoelectric sensors for detecting whether an occupant is in a particular seat and the weight of the occupant.

The other sensors 156 may include a gear selector and/or shifter sensor 167, a vehicle speed sensor 166, acceleration sensors (e.g., longitudinal and lateral acceleration sensors) 168, and a fuel level sensor 170, as shown, and other sensors such as an inclinometer, an engine temperature sensor, and an engine oil pressure sensor. Additional sensors may also be included such as brake system sensors (a brake sensor 179 is shown) and steering system sensors (a steering angle sensor 181 is shown). The gear selector and/or shifter sensor 167 generates a signal indicative of a state of the gear selector and/or shifter 135.

The driving module 104 may use machine learning for facial recognition, determining locations of occupant limbs, for anatomical feature recognition, object classification including to identify and/or classify pedestrians, cyclists, and vehicles (e.g., oncoming traffic), roadway markings and objects, as well as for probable trajectory determination of each detected, identified and/or classified object. The driving module 104 may determine the locations of objects based on feedback from the sensors 150.

The vehicle control module 103 may also include a mode selection module 172 and a parameter adjustment module 174. The parameter adjustment module 174 may be used to adjust parameters of the host vehicle 100. The vehicle control module 103 may perform autonomous operations based on interaction with a vehicle occupant. As an example, the vehicle control module 103 may operate in a fully or partially autonomous mode and may control the propulsion system 110, a brake system 176, and a steering system 178. In an embodiment, the vehicle control module 103 controls operation of the systems 110, 176 and 178 based on or without interactions with a vehicle occupant. The vehicle control module 103 may i) perform autonomous operations such as steering, braking, accelerating, etc., and/or ii) display and/or audibly playout messages, perform haptic operations via haptic devices, and/or output messages and/or corresponding signals via other output devices.

In an embodiment, the driving module 104 uses computer vision, machine learning and cloud computing to identify, communicate, and evaluate scenarios where a moving host vehicle should yield to pedestrian(s), an obstructed roadway, and/or oncoming (right-of-way) traffic. The driving module 104 visualizes and takes into consideration in real-time pedestrians, roadway obstructions and oncoming traffic and performs operations to provide enhanced situation awareness to vehicle occupants.

The driving module 104 is configured to perceive the road ahead and surrounding areas based on outputs of sensors (e.g., cameras, radar sensors, and/or lidar sensors) and vehicle-to-everything (V2X) communication including vehicle-to-vehicle communication, vehicle-to-mobile device communication, vehicle-to-infrastructure communication, and other communication (e.g., vehicle to distributed network communication).

The host vehicle 100 may further include the memory 180. The memory 180 may store sensor data 182, parameters 184, applications 186, algorithms 188, historical data 190, on-board inputs 191, off-board inputs 192 from other devices external to the host vehicle 100 and other data 193. The sensor data and parameters may include occupant locations, occupant weights, occupant heart rates, vehicle location, vehicle speed, vehicle acceleration, battery state of charge, fuel level, etc. applications 186. The applications 186 may include applications executed by the modules 102-108.

Although the memory 180 and the vehicle control module 103 are shown as separate devices, the memory 180 and the vehicle control module 103 may be implemented as a single device. The memory 180 may also store historical data 190 and other data 193 such as driver driving patterns (e.g., vehicle speed history), driver fueling patterns, driver stopping patterns, driver pickup patterns, other driver patterns, data collected by and/or generated by at least one of the modules 102-106, traffic data, navigation data, map data, GPS/GNSS data, path data, speed data, and acceleration data, etc.

The vehicle control module 103 may control operation of the propulsion system 110, the video system including the display 120, 121, the audio system 122, the haptic devices, the brake system 176, the steering system 178, a seating system 196, and/or other devices and systems according to parameters set by the modules 102-108, 174. The seating system 196 may include seat sensors 197 for detecting presence of an occupant and/or change in occupants, for example, change in a driver. The vehicle control module 103 may set at least some of the parameters based on signals received from the sensors 150.

The vehicle control module 103 may receive power from the power sources 109, which may be provided to the propulsion system 110, the brake system 176, the steering system 178, the seating system 196, etc. Power supplied to the haptic devices, the motors 132, the brake system 176, the steering system 178, the seating system 196, and/or actuators thereof may be controlled by the vehicle control module 103 to, for example, adjust: motor speed, torque, and/or acceleration; braking pressure; steering wheel angle; pedal position; state of haptic devices; etc. This control may be based on the outputs of the sensors 150, the navigation module 114, the GPS and GNSS receiver 116, the data and information received from external devices, and the data and information stored in the memory 180.

The vehicle control module 103 may determine various parameters including a vehicle speed, a motor speed, a gear state, an accelerator position, a brake pedal position, an amount of regenerative (charge) power, an amount of auto start/stop discharge power, and/or other information. The vehicle control module 103 may control operations of the systems 110, 176, 178 based on the stated parameters. The driving module 104 may display vehicle status information based on the stated parameters.

The host vehicle 100 can include various systems for assisting a driver, for performing autonomous operations, and/or for indicating to a vehicle occupant information regarding an environment of the host vehicle. For example, a host system may include a navigation system that provides map information indicating lane boundaries, street locations, speed limits, geographical locations of selected destinations, etc. The host system may provide the driver with instructions for driving to a selected destination and/or may perform autonomous operations such as braking, steering, and accelerating operations to drive the vehicle to the destination based on the map information.

FIG. 2 shows a speed versus time graph illustrating speed limit windows 200a, 200b, 200c, 200d (collectively speed limit windows 200) with respective speed ranges having upper bounds 202 and lower bounds 204. The speed limit windows are used to determine when a driver has been driving within a given speed range for a period of time. A dashed maximum speed limit curve 206 is shown having maximum speed limits SL1, SL2, SL3, SL4 and SLT. As an example, SL1, SL2, SL3, SL4 and SLT may be respectively 130 kph, 100 kph, 80 kph, 60 kph, and 40 kph. Other maximum speed limits may be set. Although four speed limit windows are shown, any number of speed limit windows may be included and used to drop a current vehicle speed to below the target maximum vehicle speed SLT.

A dotted minimum speed limit curve 208 is shown having minimum speed limits (referred to as a floor). The floor may be set based on local, regional, and/or national safety requirements. The floor may refer to minimum speed limits for a particular road. In the example shown, the maximum speed limit curve 206 and the minimum speed limit curve 208 are equal during the first speed limit windows 200a and after the fourth speed limit window 200d. Curve 210 represents the actual speed of the host vehicle.

Speed limit windows 200a, 200b, 200c include periods during which the curve 210 (or speed of the host vehicle) remains within the speed ranges of the windows 200a, 200b, 200c. As an example, the speed limit imposed by the speed limiting module 102 is reduced to a next speed limit when the speed of the host vehicle remains within the speed range of the current speed limit window for a transient predetermined period of time (e.g., 10 s). The transient timer is reset each time the speed enters a speed limit window and stops each time the speed exits a speed limit window. The continuous time periods when the speed remains within the speed range of the current speed limit window are represented by boxes 212a, 212b, 212c. Boxes 212a, 212b, 212c indicate that the speed has been in the current speed limit window long enough to trigger a change in a maximum speed limit.

Periods during which the speed of the host vehicle is within the speed range of a corresponding speed limit window but not for less than the transient predetermined period of time are represented by boxes 220. During the periods of boxes 220, the transient timer is maturing but has not reached the transient predetermined period of time associated with triggering a change in a current maximum speed limit. The transient predetermined period of time is calibratable. If the speed of the vehicle exits a speed limit window above or below, the transient timer for being in the speed limit window resets but the cumulative timer and the maximum timer do not reset. When the speed is going in and out of speed limit window, then driving conditions are actively changing. In the example shown, the speed drops below the speed range of the speed limit window 200a at 222 and the transient timer is reset. The resetting of the transient timer as described prevents tighter speed limits caused by variable speeds or events. Tighter speed limits than current road conditions require are prevented, for example, during stop and go traffic or when the host vehicle gets cut off by another vehicle.

The upper bound of a current speed limit window is a same speed as a next imposed maximum speed limit. The maximum speed limits may be above the upper bounds of the speed limit windows, for current instances in time, as not to overly limit driving actions (e.g., not overly limit speed at which the driver wants to drive). The higher the imposed maximum speed limits are relative to the upper bounds of the speed limit windows, the less likely the driver requested speed is at or above an imposed maximum speed limit. The speed limiting module 102 operates to induce driver to change driving behavior and stop current drive cycle without hindering the driver's ability to drive at desired speeds while satisfying safety speed requirements.

The cumulative timer indicates the amount of time the speed has been in the speed limit window and resets when the maximum speed limit is stepped down to a next maximum speed limit. The maximum timer indicates the amount of time speed limiting has been enabled due to a fault, operation in a speed limiting mode, and/or other condition. The speed limit windows 200 may be used to infer change in road type or current driving needs based on whether the speed of the host vehicle is within or outside of the speed limit windows 200.

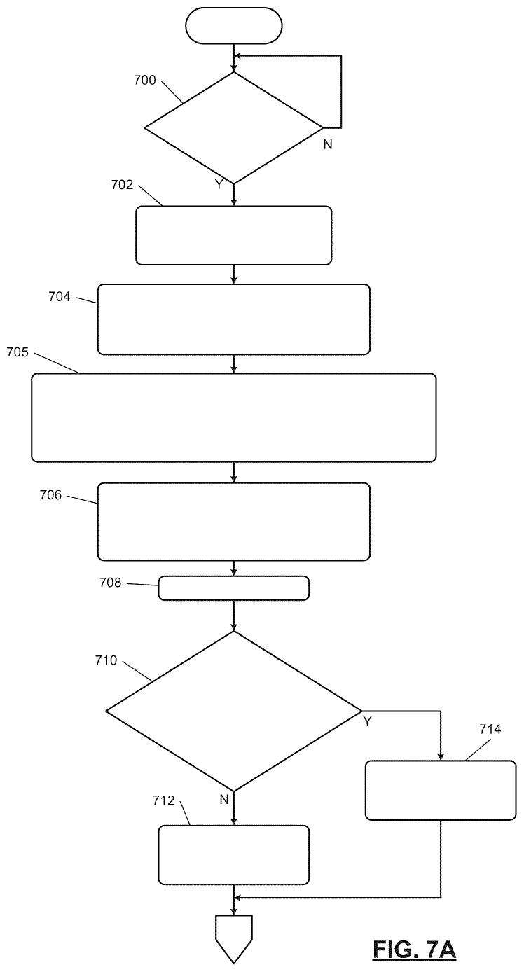

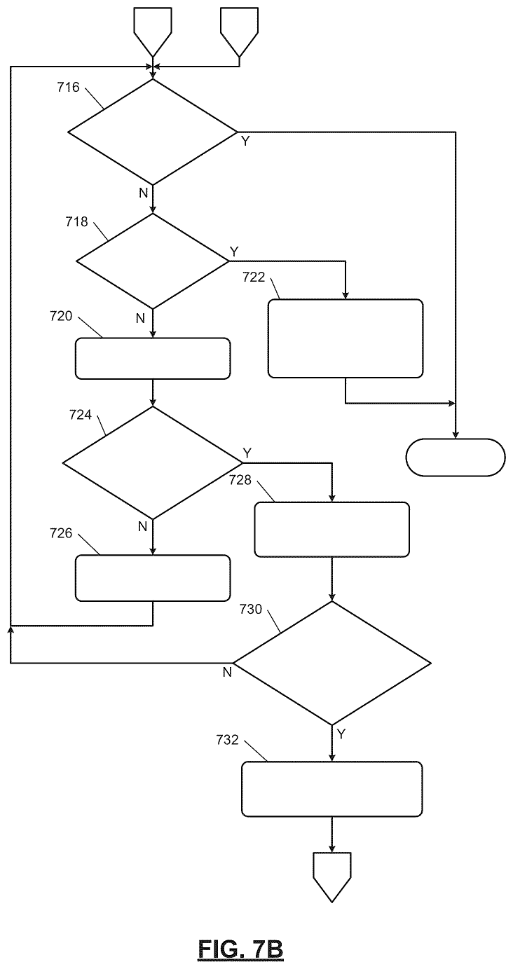

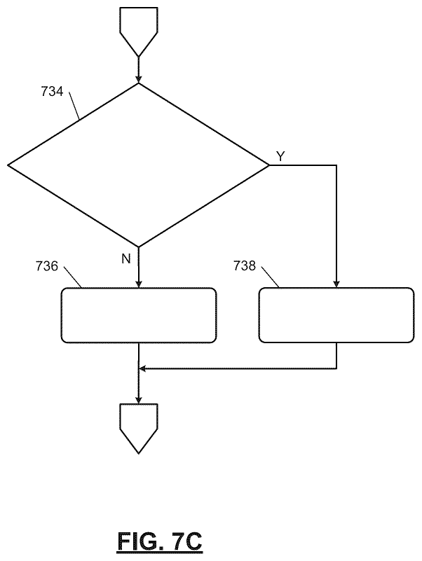

The upper bounds 202 of the speed limit windows 200 are lower respectively than the maximum speed limits SL1, SL2, SL3, SL4. The lower bounds 204 of the speed limit windows 200a, 200b, 200c, 200d are lower than respectively the next imposed speed limits SL2, SL3, SL4, SLT. The initial speed limit SL1 and/or current active speed limit window including the upper and lower bounds and duration may be determined based on an averaged vehicle speed for a last predetermined period of time (e.g., 10-60 s). A lag filter may be used to determine the speed. As an example, an average speed over the last 10 s may be averaged and used to determine a first maximum speed limit and thus a first speed limit window range. A historic driver averaged speed over extended period of time is used to determine initial maximum speed limit such that the initial maximum speed limit is above the average speed. This is further described below with respect to operation 704 of FIG. 7A. To prevent large changes in the maximum speed limit there is only one maximum speed limit pending at a time. This is relevant when a desired maximum speed limit is below the speed floor (or minimum speed limit).

After a maximum time tₘₐₓ (e.g., 300 s), the vehicle maximum speed limit is SLT (e.g., 40 kph). If the current speed limit is higher than SLT, then the SLT speed limit is imposed at a ramp down start time before tₘₐₓ such that the ramp down in vehicle speed is completed at the maximum time tₘₐₓ (e.g., 300 s). This is done regardless of driver behavior (i.e., speed requested by driver). Ramp down time t_{rd} to get to the target maximum speed limit SLT (e.g., 40 kph) is equal to maximum time tₘₐₓ (e.g., 300 s) minus a ratio of a current vehicle speed Vc minus the target maximum speed limit SLT relative to a speed reduction ramp down rate RATE, which may be represented by equation 1. As an example, the ramp down rate RATE may be 2 kph/s, 3 kph/s, 3.5 kph/s or other rate. This rate may be calibrated.

$${t}_{rd} = {t}_{max} - \frac{Vc - SLT}{Rate} \qquad ( 1 )$$

For the lowest (or bottom) speed limit (or speed pending) window (e.g., speed limit window 200d), the lower bound of the window is set to a low but non-zero speed to avoid ratcheting speed down when in stopped traffic. The lower bound (or lower threshold) may be set to a lowest “moving” speed defined by electronic transmission range selection (ETRS). An indicator light may be displayed and/or a message may be displayed when a top speed is limited to 135 kph or less. This may be done via the HUD 121 or one of the displays 120 of FIG. 1.

To prevent getting stuck at a speed limit higher than the target speed limit SLT when there is a large number of changes in driving needs (i.e., the speed of the host vehicle varies greatly and often during a speed limit window such that the speed does not remain in the window for the transient predetermined period of time), the speed limit windows 200 may overlap in speed by a predetermined amount. The overlap is represented by numerical designators 230, 232, 234.

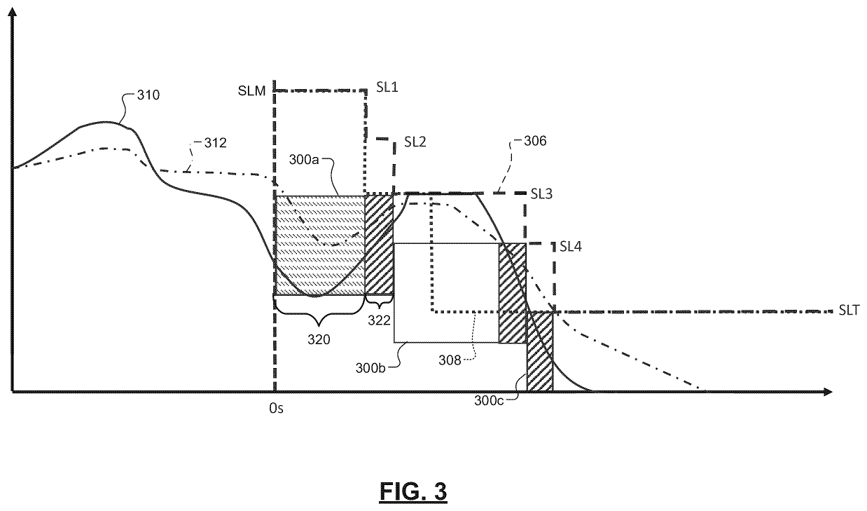

FIG. 3 shows a speed versus time graph illustrating use of filtered speed to determine an initial speed limit window 300a and delay due to a current maximum speed limit SL1 being equal to a minimum speed limit SLM (or floor). A dashed maximum speed limit curve 306 is shown having maximum speed limits SL1, SL2, SL3, SL4 and SLT. As an example, SL1, SL2, SL3, SL4 and SLT may be respectively 130 kph, 100 kph, 80 kph, 60 kph, and 40 kph. A dotted minimum speed limit curve 308 is shown having minimum speed limits (referred to as a floor). Curve 310 represents actual speed of the host vehicle. Curve 312 represent filtered vehicle speed.

A second speed limit window 300b and a third speed limit window 300c are shown. The first speed limit window 300a includes a first period 320 during which the maximum speed limit SL1 is equal to the minimum speed limit SLM and a second period 322 during which the maximum speed limit SL1 is not equal to the minimum speed limit SLM and the speed of the vehicle is within the initial speed limit window 200a. During the first period 320, evaluation of speed limit window range is delayed due to maximum speed limit pending of SL2. There is only one maximum speed limit pending at a time.

At time 0, a pull over may be requested (i.e., a request for the driver to drive the vehicle to a side of a current road and stop the vehicle) by the vehicle control module 103 and/or the speed limiting module 102 of FIG. 1. The filtered vehicle speed 312 is used to determine the speed limit windows 300a, 300b, 300c. This captures current average driving conditions (i.e., current average speed of host vehicle). Based on the average speed 312, a desired maximum speed limit may be SL2 (e.g., 100 kph) with an active speed limit window having an upper bound equal to SL3 (e.g., 80 kph). An active speed limit window refers to a current speed limit window being used to evaluate speed of the host vehicle. In the example shown, the driver ended the trip (or drive cycle) prior to a maximum predetermined period of time (e.g., 300 s) in which the driver was allotted to reduce the speed of the vehicle to 0.

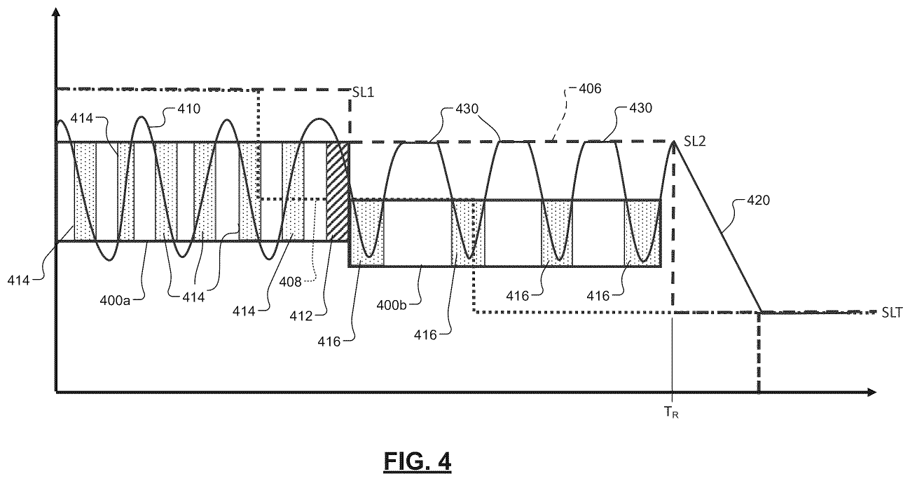

FIG. 4 shows a speed versus time graph illustrating decrease in maximum speed limit due to cumulative timer exceeding cumulative period limit. Speed limit windows 400a, 400b are shown. A dashed maximum speed limit curve 406 is shown having maximum speed limits SL1, SL2, and SLT. As an example, SL1, SL2, and SLT may be respectively 120 kph, 100 kph, and 40 kph. A dotted minimum speed limit curve 408 is shown having minimum speed limits (referred to as a floor). Curve 410 represents actual speed of the host vehicle. An end period when the speed of the host vehicle is in the first speed limit window 400a is represented by box 412. Other periods when the speed of the host vehicle is in the first speed limit window 400a are represented by boxes 414. Periods when the speed of the host vehicle is in the second speed limit window 400b are represented by boxes 416.

The cumulative timer is used to determine the amount of time that the speed is in each of the speed limit windows 400a, 400b. A predetermined cumulative period of time may be used to limit the amount of time that the maximum speed limits SL1 and SL2 are imposed. In the example shown, the maximum speed limit is transitioned from SL1 to SL2 when the cumulative timer equals the predetermined cumulative period (e.g., 60 s). This may occur prior to the transient timer timing out (i.e., the speed of the host vehicle remaining in the current speed limit window for the transient predetermined period of time). The maximum speed limit may be forced to SLT (e.g., ramped down to 40 kph) before the maximum period of time (e.g., 300 s of operation after speed limiting is enabled) has occurred. This may occur regardless of driver behavior. The ramp down period for the speed of the host vehicle is represented by linear portion 420 of curve 410 and starts at the ramp down start time T_{R} and ends at the maximum time Tmax (e.g., 300 s). As an example, the ramp down rate may be 2 kph/s. In the example shown, the speed of the host vehicle is limited by SL2 during the period of the second speed limit window 400b, as shown by linear portions 430 of curve 410.

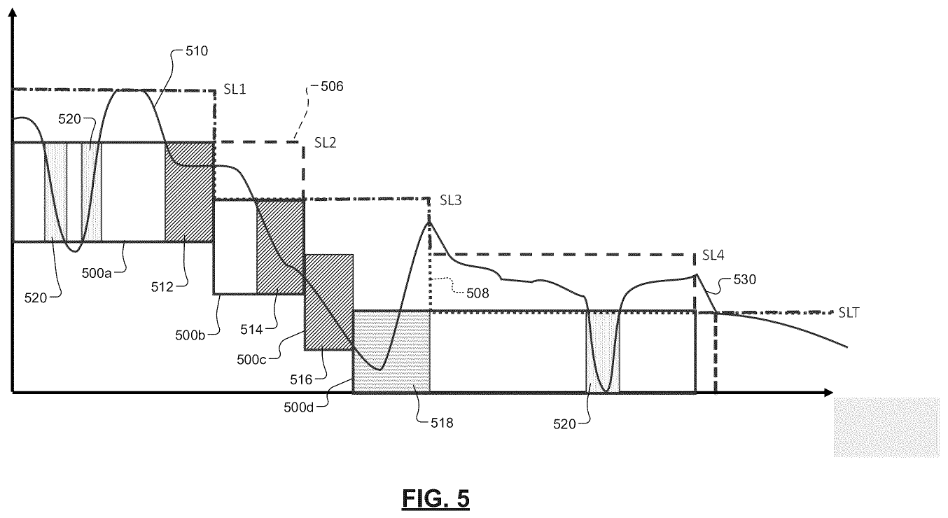

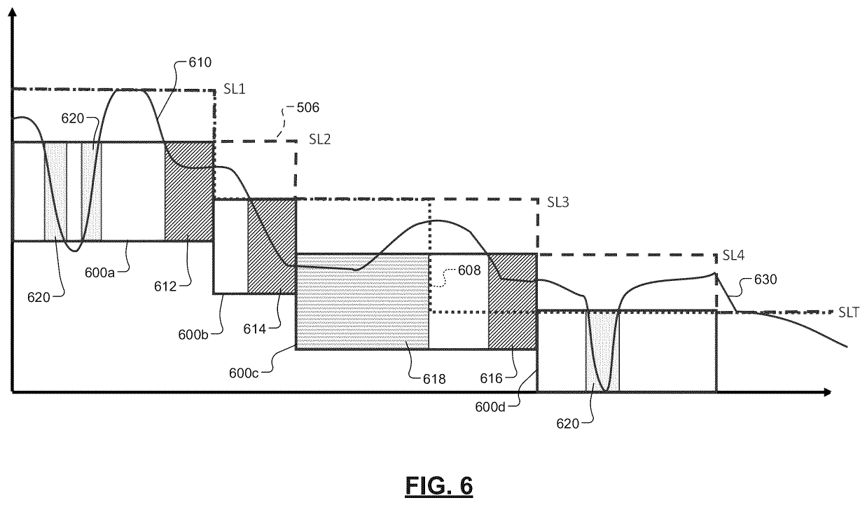

FIGS. 5 and 6 are examples for handling when the speed floor is equal to a maximum speed limit. FIG. 5 shows a speed versus time graph illustrating a first speed floor handling method including delaying maximum speed limit reduction due to a current maximum speed limit equaling a minimum speed limit until the minimum speed limit is reduced. The speed limiting module 102 waits to lower maximum speed limit based on speed floor timing (i.e., when minimum speed limit transitions to a lower minimum speed limit).

Speed limit windows 500a, 500b, 500c, 500d are shown. A dashed maximum speed limit curve 506 is shown having maximum speed limits SL1, SL2, SL3, SL4, and SLT. As an example, SL1, SL2, SL3, SL4, and SLT may be respectively 130 kph, 100 kph, 80 kph, 60 kph, and 40 kph. A dotted minimum speed limit curve 508 is shown having minimum speed limits (referred to as a floor). Curve 510 represents actual speed of the host vehicle. An end period when the speed of the host vehicle is in the first speed limit window 500a is represented by box 512. An end period when the speed of the host vehicle is in the second speed limit window 500b is represented by box 514. An end period when the speed of the host vehicle is in the third speed limit window 500c is represented by box 516.

Box 518 represents a period when the maximum speed limit (e.g., SL3) is equal to the minimum speed limit indicated by the minimum speed limit curve 508 and there is a speed limit pending, meaning the speed limiting module 102 holds off evaluating the speed of the host vehicle relative to the speed limit windows 500b, 500c and 500d and thus stepping down the maximum speed limit until the end of the period of box 518. The lowering of the maximum speed limit is as a result delayed. The maximum speed limit SL4 is pending (i.e., determined as a next maximum speed limit but not imposed) until the minimum speed limit is less than the current maximum speed limit. The delay occurs even when the speed of the host vehicle is within a speed limit window for the transient predetermined period of time, which is the case for the period of box 516. The maximum speed limit is not reduced at the end of speed limit windows 500b and 500c. The maximum speed limit is reduced from SL3 to SL4 at the end of period 518. Period 518 is a beginning portion of speed limit window 500d.

Periods when the speed of the host vehicle is in a speed limit window but not long enough to exceed the transient predetermined period of time are represented by boxes 520. A linear ramp down period is shown by linear portion 530 of the speed curve 510.

FIG. 6 shows a speed versus time graph illustrating a second speed floor handling method including delaying evaluation of whether to perform a maximum speed limit reduction due to a current maximum speed limit equaling a minimum speed limit until the minimum speed limit is reduced. The speed limiting module 102 waits to evaluate based on speed floor timing. The speed limiting module 102 waits to evaluate a next speed limit window until the speed limiting module 102 is able to execute the next step-down transition in the maximum speed limit.

Speed limit windows 600a, 600b, 600c, 600d are shown. A dashed maximum speed limit curve 606 is shown having maximum speed limits SL1, SL2, SL3, SL4, and SLT. As an example, SL1, SL2, SL3, SL4, and SLT may be respectively 130 kph, 100 kph, 80 kph, 60 kph, and 40 kph. A dotted minimum speed limit curve 608 is shown having minimum speed limits (referred to as a floor). Curve 610 represents actual speed of the host vehicle. An end period when the speed of the host vehicle is in the first speed limit window 600a is represented by box 612. An end period when the speed of the host vehicle is in the second speed limit window 600b is represented by box 614. An end period when the speed of the host vehicle is in the third speed limit window 600c is represented by box 616.

Box 618 represents a period when the maximum speed limit (e.g., SL3) is equal to the minimum speed limit 608 and control is waiting to evaluate vehicle speed against the speed limit window 600c during the period of 618. The speed limiting module 102 holds off evaluating the speed of the host vehicle relative to the speed limit window 600c during the period of 618 and holds off stepping down the maximum speed limit until the end of the period of box 616. The evaluation and lowering of the maximum speed limit are delayed. The maximum speed limit SL4 is pending until the minimum speed limit is less than the current maximum speed limit. The delay occurs even when the speed of the host vehicle is within a speed limit window for the transient predetermined period of time, which is the case for the period of box 614. The maximum speed limit is not reduced during a beginning portion of speed limit window 600c. The maximum speed limit is reduced from SL3 to SL4 at the end of speed limit window 600c due to the delay and the speed of the host vehicle not being in the speed limit window 600c after the period of box 618 and for the transient predetermined period of time until then end of speed limit window 600c.

Periods when the speed of the host vehicle is in a speed limit window but not long enough to exceed the transient predetermined period of time are represented by boxes 620. A linear ramp down period is shown by linear portion 630 of the speed curve 610.

FIGS. 7A-7C show a speed limiting method. The operations may be iteratively performed by the speed limiting module 102 of FIG. 1. At 700, the speed limiting module 102 determines whether there is a fault, whether a driving mode has been started that imposes a maximum speed limit, and/or other condition exists to implement adaptive speed limiting to reduce speed of the vehicle. If yes, operation 702 may be performed.

At 702, the speed limiting module 102 determines an average speed of the host vehicle over a previous predetermined period of time (e.g., 10-60 s).

At 704, the speed limiting module 102 determines a target maximum speed limit, maximum speed limits for the adaptive speed limiting process being implemented, and/or minimum speed limits (or floor). The target maximum speed limit may be based on the detected fault, the driving mode, etc. In an embodiment, the maximum speed limits may be predetermined fixed and stored in memory. In another embodiment, the maximum speed limits are set based on the target maximum speed limit, the average speed of the host vehicle, and a predetermined number of maximum speed limits to include. The minimum speed limits may be determined: based on signal outputs of exterior sensors (e.g., cameras), which are used to read speed limit signs; based on GPS information received; based on signals from nearby vehicles (V2V communication), and/or based on other received signals. The minimum speed limits may be stored in memory as profiles of speed versus time.

At 705, the speed limiting module 102 determines speed limit windows based on the average speed of the host vehicle, a number of speed limit windows to include, the target maximum speed limit, differences between the maximum speed limits, and/or differences between upper and lower bounds of the speed limit windows. The number of steps (or number of upper bounds of respective speed limit windows) may be fixed, variable, and/or calibratable. In an embodiment, the speed limiting module 102 interpolates steps (or upper bounds of the speed limit windows) between a current speed of the host vehicle and a target speed based on a predetermined number of steps. In another embodiment, the speed limiting module 102 uses constant maximum speed limits and varies the number of steps to determine the upper bounds of the speed limit windows. In yet another embodiment, the speed limiting module 102 uses fixed differences between maximum speed limits to determine upper bounds of the speed limit windows. The lower bounds of the speed limit windows may be fixed amounts less than the respective corresponding upper bounds.

At 706, the speed limiting module 102 compares the average speed to the set maximum speed limits and selects a lowest speed limit that is greater than the average speed as the current desired maximum speed limit. At 708, the speed limiting module 102 resets the maximum timer to 0.

At 710, the speed limiting module 102 determines whether the desired maximum speed limit is less than a minimum speed limit for a current period of a current speed limit window. If there is no minimum speed limit, then the minimum speed limit is set equal to 0. If the desired maximum speed limit is not less than the minimum speed limit, then operation 712 may be performed, otherwise operation 714 may be performed.

At 712, the speed limiting module 102 sets the current maximum speed limit to the desired maximum speed limit. At 714, the speed limiting module 102 sets the current maximum speed limit to the minimum speed limit. Operation 716 may be performed after operations 712 and 714.

At 716, the speed limiting module 102 determines whether a final desired speed limit is reached. If not, operation 718 may be performed, otherwise the method may end.

At 718, the speed limiting module 102 determines whether the maximum timer has expired indicating that the speed limiting process has been implemented for the maximum time Tmax. If there is no maximum time, treat maximum time as infinite such that operation 720 is performed. If the maximum timer has not expired, operation 720 may be performed, otherwise operation 722 may be performed.

At 720, the speed limiting module 102 initiates the cumulative timer.

At 722, the speed limiting module 102 sets the current maximum speed limit to the final desired (or target) maximum speed limit.

At 724, the speed limiting module 102 determines whether the current speed of the host vehicle is within the current speed limit window. If not, operation 726 may be performed, otherwise operation 728 may be performed.

At 726, the speed limiting module 102 resets the transient timer.

At 728, the speed limiting module 102 increments the transient timer and the cumulative timer.

At 730, the speed limiting module 102 determines whether the transient timer is greater than a first threshold and/or the cumulative timer is greater than a second threshold. If either are true, then operation 732 may be performed. If neither are true, then operation 716 may be performed.

At 732, the speed limiting module 102 sets a desired maximum speed limit to a next lower maximum speed limit.

At 734, the speed limiting module 102 determines whether the desired maximum speed limit is less than the minimum speed limit. If there is no minimum speed limit, then the minimum speed limit is set equal to 0. If the desired maximum speed limit is not less than the minimum speed limit, then operation 736 may be performed, otherwise operation 738 may be performed.

At 736, the speed limiting module 102 sets the current maximum speed limit to the desired maximum speed limit. At 738, the speed limiting module 102 sets the current maximum speed limit to the minimum speed limit. Operation 716 may be performed subsequent to operations 736 and 738.

The above-described operations are meant to be illustrative examples. The operations may be performed sequentially, synchronously, simultaneously, continuously, during overlapping time periods or in a different order depending upon the application. Also, any of the operations may not be performed or skipped depending on the implementation and/or sequence of events.

The above-described examples include using speed limit windows to determine when a decrease in a maximum speed limit would be least imposing on a driver based on current driver behavior. Adaptive and progressive speed limitations are imposed as opposed to using only a linear speed ramp down to a target speed limit. Recent driving history is used to determine which initial speed limit to impose. The disclosed methods honor speed limit “floor” requirements (e.g., minimum road speed laws, safety, vehicle availability requirements). Driver feedback about the maximum speed limits is used in an attempt to modify driver behavior such that the driver is at least partially in control of when a final desired speed limit is reached.

The examples implement a methodology that uses a series of speed limit windows consisting of upper and lower bounds with associated speed limits that are greater than or equal to the upper bound to gradually reduce a vehicle maximum speed limit to a target final maximum speed limit. If a moving window average of driver speed is within one of these windows for a continuous period of time, then a transition to a new speed limit is triggered. If a speed limit window is exited, there is still a cumulative timer that accounts for the length of time the driver has been driving at speeds within that speed limit window. When this non-continuous time exceeds a threshold, a transition is triggered to a new maximum speed limit.

All potential maximum speed limits are compared against a minimum required speed availability. When the desired speed limit is below this availability, then the desired speed limit shall be set to the minimum required speed availability. If there is a maximum allowable time to reach the final desired maximum speed limit, then the methodology imposes the final desired maximum speed limit regardless of driver behavior after the maximum allowable time is exceeded. When a new desired maximum speed limit is determined, the driver is informed of the new desired maximum speed limit.

A driver maximum speed limit is set higher than current vehicle speed, taking into account driving conditions (minimizing the risk of a speed ramp down due to the maximum speed limit being lower than a current speed, which could lead to a collision). The methodology provides maximum speed “availability” to the driver (i.e., does not over limit the driver in host vehicle speed, as opposed to following a linear speed ramp down, while still incentivizing the driver to end a current drive cycle thus meeting safety requirements and reducing residual safety risk. Speed limit notification is provided to the driver prior to the vehicle speed dropping below or being equal to the maximum speed limit to encourage change in driving behavior.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general-purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, Javascript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

What is claimed is:

1. An adaptive speed limiting system comprising:
a propulsion system configured to move a host vehicle;
a vehicle control module configured to i) at least one of detect a fault in the host vehicle and enable operation in a driving mode during which a maximum speed limit is imposed, and ii) at least one of limit output torque of the propulsion system and speed of the host vehicle based on a current maximum speed limit; and
a speed limiting module configured to i) based on at least one of the detected fault and operation in the driving mode, initiate adaptive speed limiting to impose the current maximum speed limit to change driving behavior, ii) determine a plurality of speed limit windows having respective speed ranges, iii) determine an average speed of the host vehicle, and iv) based on the average speed and the plurality of speed limit windows, periodically decrease the current maximum speed limit until the current maximum speed limit is equal to a target maximum speed limit.

2. The adaptive speed limiting system of claim 1, wherein:
the speed limiting module is configured to i) monitor the speed of the host vehicle, and ii) in response to the speed of the host vehicle remaining within upper and lower bounds of a current one of the plurality of speed limit windows for a transient predetermined period of time, decrease the current maximum speed limit to a next lower one of a plurality of maximum speed limits; and
the plurality of speed limit windows correspond respectively to the plurality of maximum speed limits.

3. The adaptive speed limiting system of claim 1, wherein the speed limiting module is configured to iteratively step down the current maximum speed limit until the current maximum speed limit is equal to the target maximum speed limit.

4. The adaptive speed limiting system of claim 1, wherein the speed limiting module is configured to:
reset a transient timer each time the speed of the host vehicle exits one of the plurality of speed limit windows;
iteratively increment the transient timer while the speed of the host vehicle is in the one of the plurality of speed limit windows; and
based on the transient timer, decrease the current maximum speed limit.

5. The adaptive speed limiting system of claim 4, wherein the speed limiting module is configured to reset the transient timer each time the speed of the host vehicle exits the one of the plurality of speed limit windows prior to the transient timer reaching a transient predetermined period of time.

6. The adaptive speed limiting system of claim 1, wherein the speed limiting module is configured to, subsequent to one or more of the plurality of speed limit windows, ramp down the speed of the host vehicle to be less than the target maximum speed limit.

7. The adaptive speed limiting system of claim 6, wherein the speed limiting module is configured to begin ramping down the speed of the host vehicle a determined period of time prior to a maximum time point from when adaptive speed limiting is initiated.

8. The adaptive speed limiting system of claim 1, wherein the speed limiting module is configured to refrain from ramping down the speed of the host vehicle during the plurality of speed limiting windows.

9. The adaptive speed limiting system of claim 1, wherein:
the speed limiting module allows a driver to adjust speed of the host vehicle during periods of the plurality of speed limiting windows while limiting the speed of the host vehicle based on respectively a plurality of maximum speed limits; and
the plurality of maximum speed limits include the current maximum speed limit.

10. The adaptive speed limiting system of claim 1, wherein the speed limiting module is configured to i) initiate a cumulative timer indicative of an amount of time the speed of the host vehicle is in one of the plurality of speed limit windows during a period when the speed of the host vehicle enters and exits the one of the plurality of speed limit windows multiple times, and ii) decrease the current maximum speed limit based on a state of the cumulative timer.

11. The adaptive speed limiting system of claim 1, wherein the speed limiting module is configured to delay determining an initial speed limiting window when the current maximum speed limit is equal to a minimum speed limit.

12. The adaptive speed limiting system of claim 1, wherein the speed limiting module is configured to delay evaluating the speed of the host vehicle relative to one of the plurality of speed limit windows when the current maximum speed limit is equal to a minimum speed limit.

13. The adaptive speed limiting system of claim 1, wherein the speed limiting module is configured to delay reducing the current maximum speed limit when the current maximum speed limit is equal to a minimum speed limit.

14. The adaptive speed limiting system of claim 1, wherein durations of the plurality of speed limit windows are different.

15. The adaptive speed limiting system of claim 1, wherein upper bounds of the plurality of speed limit windows are less than or equal to respectively a plurality of maximum speed limits imposed by the speed limiting module.

16. The adaptive speed limiting system of claim 1, wherein:
a plurality of maximum speed limits imposed by the speed limiting module are independent of a maximum speed limit indicated by speed limit sign for current geographical location of the host vehicle; and
a minimum speed limit imposed by the speed limiting module is a same value as a minimum speed limit indicated by the speed limit sign for the current geographical location.

17. An adaptive speed limiting method comprising:
moving a host vehicle via a propulsion system;
at least one of detecting a fault in the host vehicle and enabling operation in a driving mode during which a maximum speed limit is imposed;
at least one limiting output torque of the propulsion system and speed of the host vehicle based on a current maximum speed limit;
based on at least one of the detected fault and operation in the driving mode, initiating adaptive speed limiting to impose the current maximum speed limit to change driving behavior;
determining a plurality of speed limit windows having respective speed ranges;
determining an average speed of the host vehicle; and
based on the average speed and the plurality of speed limit windows, periodically decreasing the current maximum speed limit until the current maximum speed limit is equal to a target maximum speed limit.

18. The adaptive speed limiting method of claim 17, further comprising:
monitoring the speed of the host vehicle; and
in response to the speed of the host vehicle remaining within upper and lower bounds of a current one of the plurality of speed limit windows for a transient predetermined period of time, decreasing the current maximum speed limit to a next lower one of a plurality of maximum speed limits,
wherein the plurality of speed limit windows correspond respectively to the plurality of maximum speed limits.

19. The adaptive speed limiting method of claim 17, further comprising:
resetting a transient timer each time the speed of the host vehicle exits one of the plurality of speed limit windows;
iteratively incrementing the transient timer while the speed of the host vehicle is in the one of the plurality of speed limit windows; and
based on the transient timer, decreasing the current maximum speed limit.

20. The adaptive speed limiting method of claim 17, further comprising:
initiating a cumulative timer indicative of an amount of time the speed of the host vehicle is in one of the plurality of speed limit windows during a period when the speed of the host vehicle enters and exits the one of the plurality of speed limit windows multiple times; and
decreasing the current maximum speed limit based on a state of the cumulative timer.
